(19) United States
(12) Patent Application Publication
(10) Pub. No.: US 2010/0085184 A1
(43) Pub. Date: Apr. 8, 2010

(54) Electronic finder for a remote control device

(76) Inventor: Conte Cuttino, Uniondale, NY (US)

Correspondence Address: ROBERT J. BIRD, 86 FRENCH ROAD, ROCHESTER, NY, 14618, US

(21) Appl. No.: 12/584,504

(22) Filed: Sep. 8, 2009

Related U.S. Application Data
(60) Provisional application No. 61/192,374, filed on Sep. 18, 2008.

(51) Int. Cl. G08B 1/08

(52) U.S. Cl. 340/539.32

(57) ABSTRACT

An electronic finder system for locating a misplaced remote control device includes a remote control device to control the operations of associated equipment; the remote control device including an audio signal device, a visual signal device, and a vibration signal device. The remote control device further includes means to selectively render the audio, visual, and vibration signal devices operative and inoperative. An alarm actuator on the associated equipment is effective to actuate the operative signal devices on the remote control device to produce sensate signals to thereby reveal the whereabouts of the misplaced remote control device.

### CROSS-REFERENCE TO RELATED APPLICATION

My copending Provisional Patent Application No. 61/192,374 was filed on Sep. 18, 2008. That filing date is claimed for this application.

### BACKGROUND INFORMATION

This invention is an electronic finder for a misplaced remote control device of the type used to operate television receivers, radios, and the like (hereinafter “equipment”). Such a remote control device is referred to hereinafter simply as a “remote” or “RCD”.

Electronic finders for misplaced remotes are known in the prior art. The system of this invention is different from any such finders that I know of.

Prior art that I know of is a commercially available product called KeyRinger. KeyRinger is used for locating missing objects such as keys, eyeglass cases, television remotes, purses, and other commonly misplaced items. Keep a first Key Ringer handy and available (stationarily mounted, for example). To protect a certain item, attach a second KeyRinger to it. To find that item, when it is misplaced, use the first KeyRinger (or any other one) to communicate with the KeyRinger attached to the misplaced item. Thus, if keys are missing, the first KeyRinger (or any other one) can be used to locate them; if the television remote is missing, the KeyRinger attached to keys can be used to locate the remote. If you frequently misplace plural KeyRingers at the same time, the importance of having one stationarily mounted and available to find the others is even more readily apparent. To use a KeyRinger, double click the blue find button and you will hear five short beeps. For maximum range, aim the sound deflector on the face of the Key Ringer in the direction you are searching. When the misplaced KeyRinger responds, it flashes a red light and generates an alternating tone for about 15 seconds.

### SUMMARY OF THE INVENTION

In summary, this invention is an electronic finder system for locating a misplaced remote control device. The system includes a remote control device to control the operations of associated equipment; the remote control device including an audio signal device, a visual signal device, and a vibration signal device. The remote control device further includes means to selectively render the audio, visual, and vibration signal devices operative and inoperative. An alarm actuator on the associated equipment is effective to actuate the operative signal devices on the remote control device to produce sensate signals to thereby reveal the whereabouts of the misplaced remote control device.

### DRAWING

In the accompanying drawing:

FIG. 1 shows a Remote Control Device (RCD) according to this invention.

FIG. 2 represents an RCD and actuator system according to one form of this invention.

FIG. 3 represents an RCD and actuator system according to another form of this invention.

### DESCRIPTION

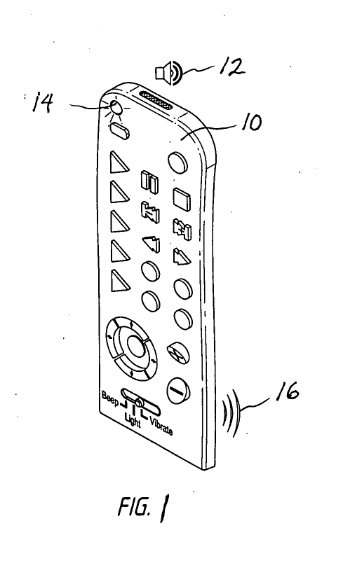

The remote control finder system of this invention includes a remote control device, and one or more alarm actuators. In FIG. 1, an RCD 10 includes an array of buttons to control the operations of associated equipment. The RCD 10 also includes an audio signal device 12, a visual signal device 14, and a vibration signal device 16. The user may select one, two, or all three of these signals, or any combination of them, and preset the device to emit alarm(s) accordingly.

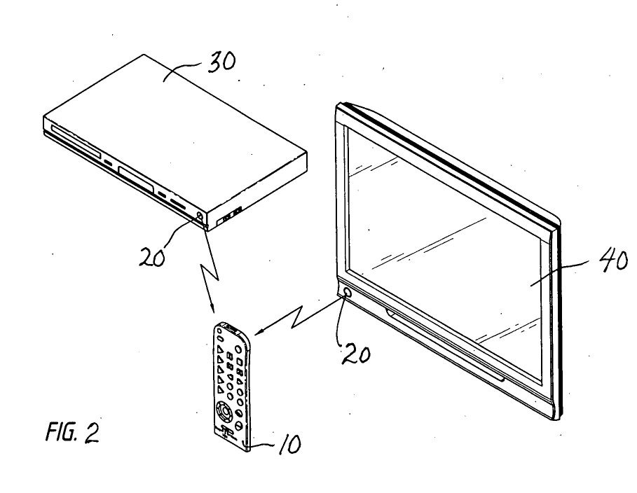

FIG. 2 represents a radio receiver 30 and a television receiver 40, each including an alarm actuator button 20 in operative relationship with the RCD 10. In the system of FIG. 2, the actuator buttons 20 are installed by the manufacturer as original equipment.

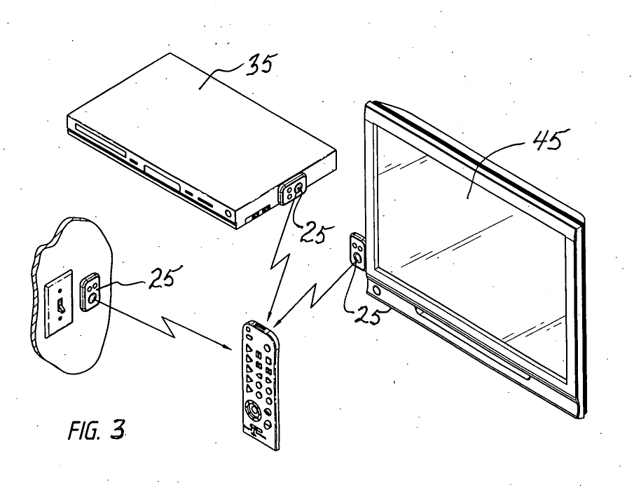

FIG. 3 represents a radio receiver 35 and a television receiver 45, each including an alarm actuator button 25 removably attached in operative relationship with an RCD 10. The system of FIG. 3 also includes an actuator button 25 placed in a convenient position other than on equipment, such as next to a light switch on the wall. In this system of FIG. 3, the actuator buttons 25 are adapted, by a suitable adhesive, for removable attachment by the user.

In the use of this system, when the RCD is misplaced, pressing the actuator button on the RCD's associated equipment actuates the alarm in the RCD. The alarm responds by sound, light, vibration, or any combination of these signals as selected by the operator to reveal the whereabouts of the RCD.

The foregoing description of preferred embodiments is illustrative of the invention. The concept and scope of the invention are limited not by the details of that description but only by the following claims and equivalents thereof.

What is claimed is:

1. An electronic finder system for locating a misplaced remote control device, said system including:
a. a remote control device including means to control the operations of associated equipment;
b. said remote control device further including an audio signal device to emit sound, a visual signal device to emit light, and a vibration signal device to produce vibration;
c. said remote control device further, including means to selectively render said signal devices operative and inoperative;
d. an alarm actuator on said associated equipment, said alarm actuator in operative engagement with said remote control device, said alarm actuator effective to actuate those signal devices on said remote control device as are operative to produce sensate signal(s) to reveal the whereabouts of said remote control device.

2. An electronic finder system as defined in claim 1, in which said alarm actuator is selectively and removably mountable on a suitable support.
